(19) United States
(12) Patent Application Publication
(10) Pub. No.: US 2026/0200488 A1
(43) Pub. Date: Jul. 16, 2026

(54) OPERATION MANAGEMENT METHOD

(71) Applicant: TOYOTA JIDOSHA KABUSHIKI KAISHA, Toyota-shi (JP)

(72) Inventor: Misato HIRANO, Yokohama-shi (JP)

(73) Assignee: TOYOTA JIDOSHA KABUSHIKI KAISHA, Toyota-shi (JP)

(21) Appl. No.: 19/435,986

(22) Filed: Dec. 30, 2025

(30) Foreign Application Priority Data
Jan. 16, 2025 (JP) 2025-006461

(51) Int. Cl. B60W 50/14; B60W 30/182; B60W 50/08; B60W 60/00; B60W 50/00

(52) U.S. Cl. CPC B60W 50/14; B60W 30/182; B60W 50/082; B60W 60/005; B60W 2050/007; B60W 2050/146; B60W 2530/18

(57) ABSTRACT

The operation management method includes: acquiring an automated driving rate, which is a ratio of a traveling distance in the automated driving mode to the total traveling distance in the scheduled traveling section, based on a traveling result measured by a vehicle traveling in the scheduled traveling section; acquiring a change rate, which is a ratio changed from a previously determined driving mode to the other driving mode with respect to the scheduled traveling section, among the automated driving mode and the manual driving mode, based on the traveling result; determining a recommended driving mode in the scheduled traveling section based on the automated driving rate and the change rate; and recommending the determined driving mode.

### CROSS-REFERENCE TO RELATED APPLICATION

This application claims priority to Japanese Patent Application No. 2025-006461 filed on January 16, 2025. The disclosure of the above-identified application, including the specification, drawings, and claims, is incorporated by reference herein in its entirety.

### BACKGROUND

### 1. Technical Field

The present disclosure relates to an operation management method.

### 2. Description of Related Art

Japanese Patent No. 7226232 (JP 7226232 B) describes a control device for an autonomous vehicle having a manual driving mode and an automated driving mode and caused to travel through automated driving in a management area managed by an operation management control device. The manual driving mode is a mode in which the vehicle travels while being steered by an operation by an operator. The automated driving mode is a mode in which the vehicle travels while being steered automatically without an operation by an operator.

### SUMMARY

There may be a road that can be traveled through automated driving according to rules determined in advance, but that is not suitable for automated driving. The conventional configuration has room for improvement in making the type of the driving mode based on the initial operation plan flexibly changeable.

An object of the present disclosure is to improve an operation management technique for an autonomous vehicle.

An aspect of the present disclosure provides

an operation management method executed by an information processing device, including:

acquiring, based on a travel performance measured by a vehicle having traveled a scheduled travel section determined in advance, an automated driving rate that is a ratio of a travel distance in an automated driving mode to a total travel distance in the scheduled travel section;

acquiring, based on the travel performance, a change rate that is a ratio of a change from one of the automated driving mode and a manual driving mode that is determined in advance for the scheduled travel section to the other driving mode;

determining a driving mode recommended for the scheduled travel section based on the automated driving rate and the change rate; and

recommending the determined driving mode.

According to an aspect of the present disclosure, an operation management technique for an autonomous vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating an exemplary configuration of a system according to an embodiment; and

FIG. 2 is a flowchart illustrating an operation example of the information processing device of FIG. 1.

### DETAILED DESCRIPTION OF EMBODIMENTS

Hereinafter, an embodiment of the present disclosure will be described below with reference to the drawings.

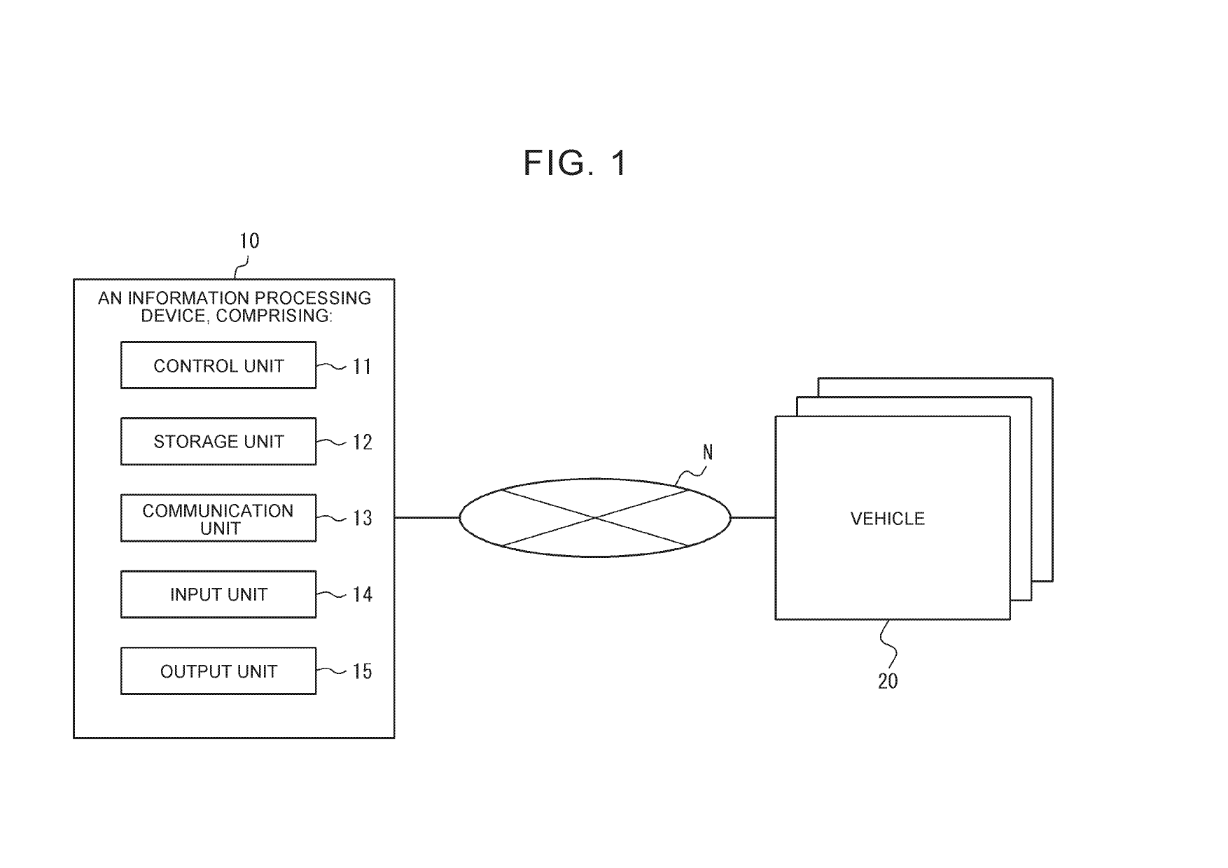

FIG. 1 is a block diagram illustrating a configuration example of a system 1 according to an embodiment. The system 1 includes an information processing device 10 and a vehicle 20. The information processing device 10 and the vehicle 20 are communicably connected to a network N including, for example, the Internet and a mobile communication network.

The information processing device 10 is one or a plurality of arbitrary computers capable of communicating with each other. The information processing device 10 may be realized by any computer such as a PC (Personal Computer), a server apparatus installed in a data center, or the like. The vehicle 20 travels on a roadway to move a person, an object, and the like. The vehicle 20 travels according to any one of a plurality of driving modes including a manual driving mode in which the vehicle travels by performing steering by an operation of an operator, and an automated driving mode in which the vehicle travels by performing steering automatically without an operation of an operator. The vehicle 20 is, for example, a gasoline vehicle. The vehicles 20 are, for example, battery electric vehicle (EV; Electric Vehicle), hybrid electric vehicle (HV; Hybrid Vehicle), or plug-in hybrid electric vehicle (PHV; Plug-in Hybrid Vehicle). The vehicles 20 are, for example, fuel cell electric vehicle (FCV; Fuel Cell Vehicle). However, the vehicle 20 is not limited thereto. The vehicle 20 may be, for example, an autonomous vehicle capable of autonomous driving corresponding to any of the levels 1 to 5 defined in SAE (Society of Automotive Engineers). In the present embodiment, the vehicle 20 can perform autonomous driving at the level 3 or 4, and the driving assistant can override the driving operation on the vehicle 20 or remotely. The number of vehicles 20 included in the system 1 may be arbitrarily determined.

In the system 1, each vehicle 20 travels in the target area in accordance with an operation plan prepared in advance by the operation manager. The operation plan may include a traveling route, an assigned vehicle (vehicle 20 to be used for traveling), an operation time period, an operation type (according to an automated driving mode/a manual driving mode), a stop, a departure date and time, and the like. The information processing device 10 manages an operation plan of each vehicle 20. For example, the information processing device 10 creates an operation plan based on an operation of the operation manager, and notifies each vehicle 20 and the driving assistant of the operation plan. In such a configuration, the operation administrator plans the operation in advance and registers the operation plan in the system 1 in advance, but it may be better to change the operation type (automatic/manual) of the operation from the initial plan for some reason. For example, in a case where the traveling route, the assigned vehicle, and the like are unsuitable for automatic driving, even in a case where the automated driving mode is set in the operation plan, it may be desirable to operate in the manual driving mode. Therefore, the information processing device 10 supports flexible change of the operation plan by recommending a more preferable driving type to the user.

Specifically, the information processing device 10 acquires the automated driving rate on the basis of the traveling result measured by the vehicle 20 traveling in the predetermined scheduled traveling section. The automated driving rate is a ratio of the traveling distance in the automated driving mode to the total traveling distance in the scheduled traveling section. The information processing device 10 acquires, based on the travel result, a change rate, which is a ratio of the automated driving mode and the manual driving mode, which is a ratio that is changed from the driving mode determined in advance to the other driving mode with respect to the scheduled traveling section. The information processing device 10 determines a recommended driving mode in the scheduled traveling section on the basis of the automated driving rate and the change rate acquired for the scheduled traveling section, and recommends the determined driving mode. As described above, the information processing device 10 determines the recommended driving type by considering not only the automated driving rate, which is the actual driving data, but also the change rate, which is the change history data of the driving type determined by the operation manager. Therefore, according to the information processing device 10, it is possible to automatically determine the driving type reflecting the setting tendency related to the driving type for each operation manager.

As illustrated in FIG. 1, the information processing device 10 includes a control unit 11, a storage unit 12, a communication unit 13, an input unit 14, and an output unit 15. The control unit 11 includes at least one processor. The processor may be a general-purpose processor such as a CPU or a special-purpose processor specialized for a particular process. The control unit 11 executes processing related to the operation of the information processing device 10 while controlling each unit of the information processing device 10. The storage unit 12 includes at least one semiconductor memory or the like. The semiconductor memory is, for example, a RAM or a ROM. The storage unit 12 functions as, for example, a main storage device, an auxiliary storage device, or the like. The storage unit 12 stores data used for the operation of the information processing device 10 and data acquired through the operation of the information processing device 10. The communication unit 13 includes at least one external communication interface. The communication interface may be either a wired communication or a wireless communication interface. For wired

communication, the communication interfaces are, for example, LAN, USB, and the like. For wireless communication, the communication interface is, for example, an interface corresponding to a mobile communication standard such as a 5G or an interface corresponding to short-range wireless communication. The communication unit 13 receives data used for the operation of the information processing device 10, and transmits data obtained by the operation of the information processing device 10. The input unit 14 includes at least one input interface. The input interface may be, for example, a physical key, a touch screen, a sound sensor that accepts voice input, a camera that accepts gesture input, or the like. The input unit 14 receives an operation of inputting data used for the operation of the information processing device 10. The output unit 15 includes at least one output interface. The output interface is, for example, a display for video output of information, a speaker for audio output of information, or the like. The output unit 15 outputs data obtained by the operation of the information processing device 10.

The function of the information processing device 10 is realized by executing the program according to the present embodiment by a processor corresponding to the control unit 11. That is, the functions of the information processing device 10 are realized by software. The program causes the computer to execute the operation of the information processing device 10, thereby causing the computer to function as the information processing device 10. That is, the computer functions as the information processing device 10 by executing the operation of the information processing device 10 in accordance with the program. In the present embodiment, the program can be recorded in a computer-readable recording medium. The computer-readable recording medium includes a non-transitory computer-readable medium, and is, for example, a magnetic recording device, a semiconductor memory, or the like. The program is distributed, for example, by selling, transferring, or lending a portable recording medium such as a DVD in which the program is recorded. Further, the program may be distributed by storing the program in the storage of the external server and transmitting the program from the external server to another computer. Further, the program may be provided as a program product. Some or all of the functions of the information processing device 10 may be realized by a dedicated circuit corresponding to the control unit 11. That is, some or all of the functions of the information processing device 10 may be realized by hardware.

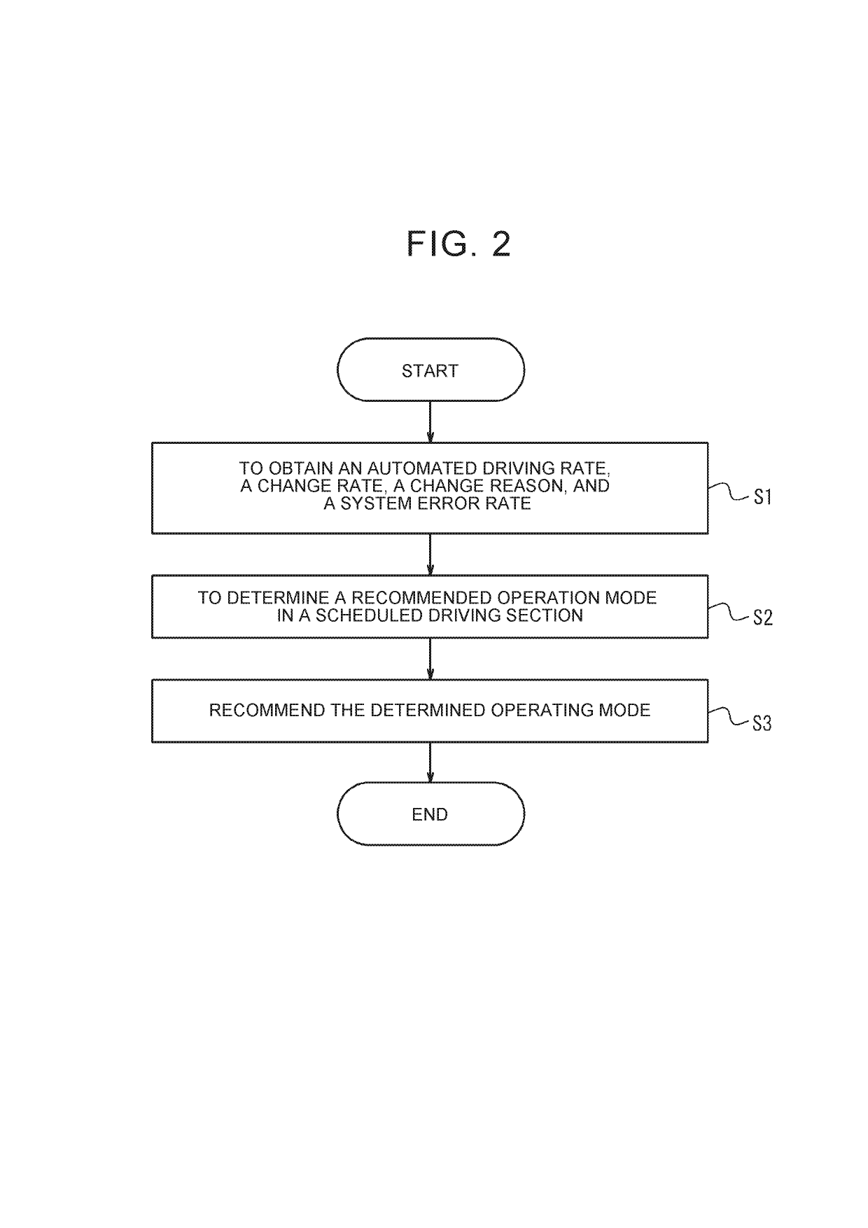

FIG. 2 is a flowchart illustrating an operation example of the information processing device 10 illustrated in FIG. 1. The operation of the information processing device 10 described with reference to FIG. 2 may correspond to one of the operation management methods. The operation of each step in FIG. 2 may be executed under the control of the control unit 11 of the information processing device 10. Hereinafter, a process of determining a recommended driving type for a predetermined scheduled traveling section will be described. Here, it is assumed that there is a usage track record of the system 1, and the information processing device 10 can refer to information on the scheduled traveling section and the past operation track record of each vehicle 20.

In S1, the control unit 11 acquires the automated driving rate, the change rate, the reason for the change, and the system error rate. The control unit 11 may acquire the automated driving rate, the change rate, the reason for the change, and the system error rate on the basis of the traveling result measured by the existing technology in each vehicle 20 traveling in the scheduled traveling section. The traveling result may include the total traveling distance in the scheduled traveling section and the traveling distance in the automated driving mode. The driving result may include a predetermined driving mode for the scheduled traveling section, a driving mode after the change when the driving mode is changed, and a reason for the change. The traveling result may include the presence or absence of a system error in which the traveling in the automated driving mode in the scheduled traveling section cannot be continued, the type of the cause of the system error (route, assigned vehicle, etc.), and the like.

The automated driving rate is a ratio of the traveling distance in the automated driving mode to the total traveling distance for the traveling of each vehicle 20 in the scheduled traveling section in a predetermined period of time in the past (for example, one latest week).

The change rate is a ratio of the automated driving mode and the manual driving mode that are changed from the operation mode determined in advance to the other operation mode with respect to the scheduled traveling section in a predetermined period of time (for example, one latest month) in the past. For example, the change rate may be a rate at which the operation mode determined in the operation plan in advance is changed according to the situation that the user, such as the operation administrator, has grasped immediately before the operation. The reason for the change is that the operation mode has

been changed. The control unit 11 may acquire the reason for the change by classifying it into, for example, one attributable to a route, one attributable to an assigned vehicle, and other reasons.

The reason for the change from the automated driving mode to the manual driving mode due to the route is, for example, that automatic driving becomes impossible due to heavy rain. The reason for changing from the automated driving mode to the manual driving mode due to the route is, for example, that there is an area in which the position accuracy is deteriorated GNSS (Global Navigation Satellite System) in the middle of the route, and the autonomous driving is difficult. The reason for the change caused by the assigned vehicle is, for example, that the vehicle 20 fails and cannot shift to the automated driving mode (change from the automated driving mode to the manual driving mode). The reason for the change caused by the assigned vehicle is, for example, that the automatic driving can be used by repair (change from the manual driving mode to the automated driving mode). The reason for the change from the other automated driving mode to the manual driving mode is, for example, weather (automatic driving cannot be performed due to fog), a crew member (a crew member who has changed the shift and has no experience of monitoring the automatic driving) and the like.

The system error rate is a rate at which the vehicle cannot continue traveling in the automated driving mode in the scheduled traveling section. The system error rate indicates the error occurrence status of the assigned vehicle according to the route or the operation plan related to the scheduled traveling section in a predetermined period of time in the past (for example, one latest day). The system error rate may be, for example, a ratio of a time at which an error related to the autonomous driving that has occurred due to the route or the assigned vehicle to a time traveled in the autonomous driving.

The change rate and the reason for the change correspond to the data when the operation type of the operation plan is changed. The control unit 11 may acquire the operation plan before and after the change as the data at the time of the operation type change. The automated driving rate and the system error rate correspond to the autonomous driving data during the operation of each operation plan.

In S2, the control unit 11 determines the recommended driving mode in the scheduled traveling section based on the automated driving rate, the change rate, the reason for the change, and the system error rate acquired by S1.

For example, the control unit 11 may further recommend the manual driving mode when the automated driving rate is lower, and may further recommend the automated driving mode when the automated driving rate is higher. This is because when the automated driving rate of the route is low, it is considered that there is a factor that hinders the autonomous driving on the route, and it is presumed that there is a possibility that the route should have been operated by the manual driving. Further, for example, the control unit 11 may further recommend the manual driving mode when the change rate of change from the automated driving mode to the manual driving mode is higher, and may further recommend the automated driving mode when the rate of change is lower. This is because when the change rate of change from the automated driving mode to the manual driving mode is low, it is presumed that the operator determines that the service operation is not affected even when the automated driving rate is low. The control unit 11 may determine the recommended operation mode in consideration of the magnitude of the change rate of change from the manual driving mode to the automated driving mode. Further, for example, the control unit 11 may determine the recommended operation mode in consideration of the reason for the change. For example, when the reason for the change is due to a route, the control unit 11 may make a determination with emphasis on the magnitude of the change rate regardless of the assigned vehicle. The control unit 11 may select the automated driving mode when the reason for the change is due to the assigned vehicle, when the automated driving rate is high, and when the change rate and the system error rate are low. Further, for example, when the system error occurrence rate of the automated driving of the assigned vehicle is higher, it is considered that an error caused by the vehicle frequently occurs. Therefore, in such a case, the control unit 11 may further recommend the manual driving mode regardless of the change rate of the driving type. Further, for example, when the system error occurrence rate of the automated driving of the route is higher, it is considered that an error caused by the route or the vehicle frequently occurs. Therefore, in such a case, the control unit 11 may further recommend the manual driving mode when the reason for changing the largest driving type is the route or the assigned vehicle. The control unit 11 may determine a recommended operation mode based on a preset rule.

In S3, the control unit 11 recommends the driving mode determined by S2 to the user. For example, the control unit 11 may output a recommended operation mode to the display of the output unit 15 or the storage unit 12. Specifically, for example, the control

unit 11 may display the determined operation mode or notify the operation mode by a pop-up or the like as a mode input by default to the operation mode selection screen. Upon completion of S3, the control unit 11 ends the process of the flowchart.

As described above, the information processing device 10 determines the recommended driving type by considering not only the actual operation data but also the change history data of the driving type determined by the operator. The performance data of the operation may be the autonomous driving data during the operation execution of each operation plan. The change history data of the driving type determined by the operator may be data at the time of changing the driving type of the operation plan. Therefore, the information processing device 10 can automatically set the driving type reflecting the setting tendency of the driving type for each operator. As a result, the operation rate and the effectiveness of the operation service are increased, and even when the number of operations to be managed and the number of vehicles 20 are increased, the load on the operation manager and the crew associated with the unplanned operation type switching can be reduced. In addition, since the recommended driving mode is determined based on the change rate of the driving mode even in a route capable of automated driving, it is possible to reduce the recommendation of a route that is not suitable for automatic driving. Therefore, the operation management technology of the autonomous vehicle is improved.

Note that the information processing device 10 may execute the above-described processing when setting a new operation plan in the scheduled traveling section and when determining whether or not to change the operation type determined in the operation plan set in advance.

The present disclosure is not limited to the embodiment described above. For example, a plurality of blocks described in a block diagram may be integrated, or one block may be divided. The steps described in the flowcharts may be performed in parallel or in a different order depending on the processing capability of the apparatus performing each step, or as needed, instead of being performed in time series according to the description. Other changes may be made without departing from the scope of the present disclosure.

What is claimed is:

1. An operation management method executed by an information processing device, comprising:
acquiring, based on a travel performance measured by an existing technique for a vehicle having traveled a scheduled travel section determined in advance, an automated driving rate that is a ratio of a travel distance in an automated driving mode to a total travel distance in the scheduled travel section;
acquiring, based on the travel performance, a change rate that is a ratio of a change from one of the automated driving mode and a manual driving mode that is determined in advance for the scheduled travel section to the other driving mode;
determining a driving mode recommended for the scheduled travel section based on the automated driving rate and the change rate; and
recommending the determined driving mode.

2. An operation management method executed by an information processing device, comprising:
determining, based on an automated driving rate and a change rate, a driving mode recommended for a scheduled travel section determined in advance, the automated driving rate being a ratio of a travel distance in an automated driving mode to a total travel distance in the scheduled travel section, and the change rate being a ratio of a change from one of the automated driving mode and a manual driving mode that is determined in advance for the scheduled travel section to the other driving mode; and
recommending the determined driving mode.

3. The operation management method according to claim 2, wherein the driving mode recommended for the scheduled travel section is determined further based on a system error rate that is a ratio of an inability to travel in the automated driving mode in the scheduled travel section.

4. The operation management method according to claim 2, wherein:
the change rate is a ratio of a change from the driving mode determined in advance for the scheduled travel section to the other driving mode made in response to an instruction from a user; and
the driving mode recommended for the scheduled travel section is determined further based on a change reason for the change from the driving mode determined in advance to the other driving mode made by the user.
